(19) United States
(12) Patent Application Publication
(10) Pub. No.: US 2026/0213632 A1
(43) Pub. Date: Jul. 23, 2026

(54) METHOD FOR RESHAPING AND INTRODUCING A WINDING INTO A ROTOR BODY OR STATOR BODY

(71) Applicant: Schaeffler Technologies AG & Co. KG, Herzogenaurach (DE)

(72) Inventors: Florian Sell-Le Blanc, Karlsruhe (DE); Fabian Oehler, Wachenheim (DE)

(21) Appl. No.: 19/139,739

(22) PCT Filed: Nov. 14, 2023
(86) PCT No.: PCT/DE2023/100870

§ 371 Date: Jun. 16, 2025

(30) Foreign Application Priority Data
Dec. 14, 2022 (DE) 10 2022 133 230.6

(51) Int. Cl. H02K 15/24

(52) U.S. Cl. CPC H02K 15/24

(57) ABSTRACT

A method for reshaping a winding and introducing the winding into a rotor body or stator body is provided. The method includes preforming a stranded wire to create the winding, such that straight sections of the stranded wire are connected via bent winding head sections of the stranded wire so as to form a wave winding or loop winding. The method also includes introducing the winding into the rotor body or stator body such that the straight sections come to lie in the slots and the winding head sections of the winding protrude on axial end faces of the rotor body or stator body. The method also includes compacting the winding head sections so as to reduce their axial protrusion.

### CROSS-REFERENCE TO RELATED APPLICATION

The present application is the U.S. National Phase of PCT Patent Application Number PCT/DE2023/100870, filed on Nov. 14, 2023, which claims priority to German Patent Application Number 10 2022 133 230.6, filed Dec. 14, 2022, the entire disclosures of which are incorporated by reference herein.

### TECHNICAL FIELD

The disclosure relates to a method for reshaping a winding and introducing the winding into a rotor body or stator body.

### BACKGROUND

When assembling rotors or stators, continuous coil windings made of copper are used. A distinction is made between concentrated and distributed windings. The latter are characterized by an almost sinusoidal course of the magnetic field in the air gap, which has a positive effect on the torque curve of the machine. The disadvantage, however, is an enlarged winding head and higher string resistance compared to the concentrated winding.

So-called flat wire windings, which consist of solid conductor wires with a rectangular cross-section, are frequently used in high-power electric machines in particular and often enable optimum utilization of the available slot cross-section in the rotor or stator. At high frequencies of the conductor current, however, current displacement effects (skin effect, proximity effect) mean that the conductor cross-section is no longer fully utilized, resulting in additional ohmic losses.

In this context, EP 3 934 067 A1 discloses a winding of an electric machine comprising a profiled stranded wire with a rectangular cross-section. Due to the large number of electrically insulated, comparatively thin individual conductors of the profiled stranded wire, the current displacement effect and the associated losses are reduced.

Distributed windings for electric machines are often manufactured as flat winding mats in the form of wave windings or loop windings and then introduced into the slots of stators or rotors. Wave windings consist of a number of interwoven conductor wires which are bent several times in opposite directions so that straight wire sections or wire lobes of the conductor wires that are parallel to one another and are intended to fill the slots of stator or rotor bodies are connected by roof-like winding heads which protrude beyond the front side of the produced rotors or stators. A flat, rotatable winding template and a wire handling device can be used to produce the wave winding as an initially flat winding mat. DE102015120963A1 describes an exemplary method for producing wave windings.

After the flat winding mat has been produced on a winding template, it is removed from said winding template and transferred to a magazine. A magazine can be designed as an elongated linear magazine, for example. It preferably has several receptacles for the conductor wires in the longitudinal direction. Alternatively, a magazine can also be designed as a rotary magazine. The receptacles are each formed between two webs, resulting in slot-like receiving spaces. In the case of a linear magazine, these groove-like receiving spaces frequently run perpendicular to the longitudinal direction in a width direction of the linear magazine. Typically, a linear magazine has a greater length in the longitudinal direction than the width in the width direction of the linear magazine. The winding mat can be compacted in the magazine and safely transferred from the manufacturing process step to a further process step in which the winding mat is inserted into a rotor body or stator body. A magazine is intended to ensure that the single wires of the winding mat and in particular the straight wire sections of the winding mat intended for insertion into slots are not displaced against each other during handling and compaction. If a wave winding as described above is inserted into a magazine and in particular into a linear magazine, the result is that in a start region and an end region of the wave winding only individual conductor wires lie in the slots of the linear magazine, and in a subregion of the linear magazine a plurality of conductor wires can also lie one above the other in the slots of the linear magazine.

The present disclosure addresses the optimization of a wave winding which is to be inserted as a coil winding in a rotor or stator. Due to the essentially cylindrical shape of rotors or stators, rotors or stators have slots that can have parallel slot flanks. Alternatively, these are designed in such a way that the tooth flanks of the teeth arranged between the slots are parallel. In the latter case, the result is conical or trapezoidal slot cross-sections when viewed in cross-section or axially with respect to the axis of rotation of the rotor or stator. An advantage of the latter embodiment is that the magnetic resistance of each tooth is the same when viewed in the radial direction.

In the case of filling the slots, it is desirable to achieve the highest possible fill factor, i.e. that the slots are be filled as completely as possible with the conductor wires in order to use the available installation space as completely as possible for electromagnetically relevant components (conductor wires). In this context, a method is known from US 2016/0 056 696 A1 in which straight sections of a wave winding are inserted into receptacles in a magazine and formed on the receptacles by shaping the conductor wires.

### SUMMARY

The disclosure is based on the object of enabling a compact design of a stator or rotor of an electric machine with advantageous electromagnetic properties.

The object is achieved by a method having the features according to claim 1, a stator having the features according to claim 11 and a rotor having the features according to claim 12. Embodiments of the disclosure can be found in the dependent claims.

The method according to the disclosure is used for reshaping and introducing a winding into a rotor body or stator body of an electric machine equipped with slots.

In a first method step, a stranded wire is first provided. The stranded wire is preferably provided in the form of a twisted stranded wire in which the individual strands, which are electrically insulated from each other, have a twist. The advantage of such a twist is that the individual strands continuously change their position in relation to the cross-sectional area of the conductor bundle over the axial expansion of a conductor bundle formed into a stranded wire. A strand arranged centrally at one axial point is positioned at another axial point in the outer area of the conductor bundle and can therefore transfer the heat generated in the strand to the slot flanks of the rotor or stator. In this way, the twist contributes to improved thermal conductivity compared to a conductor bundle with wires arranged in parallel. The strand structure can have a single stranding or twisting step of a twisted strand or a multi-stage structure with several stranding and twisting steps, which then differ in the twisting direction of the individual strand or twisted strand and the overall strand.

The particularly twisted stranded wire is then preformed into the winding, wherein the straight sections of the stranded wire are connected via bent winding head sections of the stranded wire to form a wave winding or loop winding.

The preformed winding is then inserted into the rotor body or stator body. The straight sections come to lie in the slots while the winding head sections of the winding protrude from the axial end faces of the rotor body or stator body.

The disclosure is based on the realization that there is considerable potential for reducing the axial length of a stator or rotor with a distributed winding and a stranded wire structure according to the disclosure. In principle, a distributed winding bears more axially, i.e., in the area of the end winding heads, than a concentrated winding. As a rule, flat wire windings or bar windings, which have a comparatively high rigidity, are often used, especially for higher-power electric machines such as those used for traction drives in electromobility, for example with a continuous output >50 kW. With such windings, the winding heads are already preformed during the production of the flat winding mat. Once the winding mat has been inserted into the stator or rotor, the winding heads can only be formed to a very limited extent, as the high rigidity of the conductors would require very high bending forces, which could damage the winding insulation, among other things.

On the other hand, the design of the winding based on a stranded wire according to the disclosure enables compacting of the winding head sections after the winding has been inserted into the rotor body or stator body. This is due to the significantly higher flexibility of the stranded wires. The final compacting step greatly reduces the axial protrusion of the winding heads, making it possible to provide an electric machine with a distributed winding and a considerably reduced axial length compared to the prior art.

If the stranded wire is provided as a profiled stranded wire, e.g., with a rectangular cross-section, a very high slot fill factor can be achieved. The stranded wire can already be preconfigured as profiled stranded wire or alternatively be formed into the desired profile in a magazine with corresponding slot-shaped receptacles.

The following method steps can be carried out before introducing the winding into the rotor body or stator body:
introducing the winding into a magazine, wherein the straight sections of the stranded wire are inserted into slot-shaped receptacles of the magazine,
pressing the stranded wires into the receptacles of the magazine, whereby the stranded wires are molded to the receptacles.

In particular, the straight wire sections of the stranded wires are pressed into the receptacles of the magazine, whereby the straight wire sections are shaped and the stranded wires with the straight wire sections are molded to the receptacles. In particular, it is possible for the magazine to be designed as a linear magazine. Alternatively, the magazine can be designed as a rotary magazine.

The method described above has the advantage that the magazine with its receptacles serves as a kind of former for the shaping of the stranded wire winding. Preferably, the receptacles of the magazine have the same cross-section as the slots of the rotor or stator into which the winding is inserted after shaping and removal from the magazine.

According to a further embodiment of the method, the stranded wires in the receptacles are shaped to form a substantially conical cross-section. This is particularly advantageous if the tooth flanks of the rotor or stator, which is intended for the insertion of the winding, are designed to be parallel. The parallelism of the tooth flanks has the advantage that the magnetic conductivity of the tooth flanks remains essentially constant along their radial extension. Owing to the parallel tooth flanks, the slot flanks of a substantially cylindrical rotor body or stator body, on the other hand, are not parallel and the result is a substantially trapezoidal slot cross-section.

If the stranded wire is initially preformed as a winding mat, the winding can then be rolled into a spiral shape before being introduced into the rotor body or stator body, introduced axially into the rotor body or stator body and expanded radially into the slots of the rotor body or stator body. Such a method is particularly suitable for a stator of an internal rotor machine or a rotor of an external rotor machine.

Alternatively, an embodiment of the disclosure in which the winding is inserted into a segmented stator body or rotor body is also advantageous. Here, the individual segments can be brought into engagement with a winding mat that has essentially been rolled to its final outer diameter and then connected together.

After the winding mat has been introduced into the stator or rotor, the winding heads are compacted, which is particularly effective thanks to the use of stranded wire. Preferably, the winding head sections are pressed axially against the rotor body or stator body using a compacting press. A support finger can be mounted on each stator tooth before pressing, which protects a slot projection of a slot insulation during the pressing process. This prevents damage to the slot insulation during the pressing process. In addition, the support fingers also protect the wire insulation from damage during pressing.

If a molding tool is arranged around the winding head sections, radial expansion of the winding head sections during the pressing process can be limited, thus keeping the radial installation space of the machine as compact as possible.

In an advantageous embodiment of the disclosure, compacting of the winding head sections in a radial direction in addition to axially directed compacting is achieved by using a compacting press for axial pressing, which compacting press has bevels through which the winding head sections are pressed radially outwards while the compacting press is moved axially in the direction of the rotor package or stator package.

The axial protrusion of the winding heads can be reduced even further in that, in an advantageous embodiment of the disclosure, the compacting press is rotated by a predetermined angle of rotation relative to the stator or rotor body during the axial pressing process.

In order to reduce the springback of the stranded wire in the compacted state, after compacting the winding head sections to reduce the axial protrusion, the winding is cemented to fix the winding as an optional step. For example, a material-bonding connection is made by cementing the wires with the aid of a cementing varnish. This cementing varnish is usually thermally activated and liquefies. The diffusion into the cavities of the stranded conductor and the subsequent curing solidifies the previously created structure of the conductor in the winding head, and the resulting structure is mechanically stabilized. The cementing varnish is typically a layer of special varnish that is applied as part of single strand production or in single wire production.

### BRIEF DESCRIPTION OF THE DRAWINGS

Further features, details and advantages of the disclosure result from the wording of the claims and from the following description of exemplary embodiments with reference to the drawings. In the drawings:

FIGS. 1A and 1B: show a schematic representation of the method sequence for two different variants for shaping the stranded wires in a linear magazine;

FIG. 2: shows a schematic partial representation of a top view of the linear magazine with an inserted wave winding;

FIG. 3: shows a schematic partially axial sectional view of a part of a wave winding inserted into a rotor body or stator body;

FIG. 4: shows a schematic sectional view of a stator body with inserted wave winding;

FIG. 5: shows a schematic sectional view of the stator body with inserted wave winding during compacting of the winding heads with a first embodiment of a compacting press;

FIG. 6: shows a schematic sectional view of the stator body with inserted wave winding after compacting the winding heads 24 with the first embodiment of the compacting press 40;

FIG. 7: shows a further schematic sectional view of a stator body with inserted wave winding;

FIG. 8: shows a schematic sectional view of the stator body with inserted wave winding during compacting of the winding heads 24 with a second embodiment of a compacting press 40;

FIG. 9: shows a schematic sectional view of the stator body with inserted wave winding after compacting the winding heads 24 with the second embodiment of the compacting press 40;

FIGS. 10A and 10B: show a side view of the winding heads before and after compacting; and

FIGS. 11A, 11B and 11C: show a side view of the winding heads when the compacting press rotates during the pressing process.

### DETAILED DESCRIPTION

Unless otherwise stated, the reference signs are used consistently below. Unless otherwise stated, the reference signs in the text always refer to all the figures. Likewise, unless otherwise stated, all reference signs in the figures always refer to the entire description of the exemplary embodiments below.

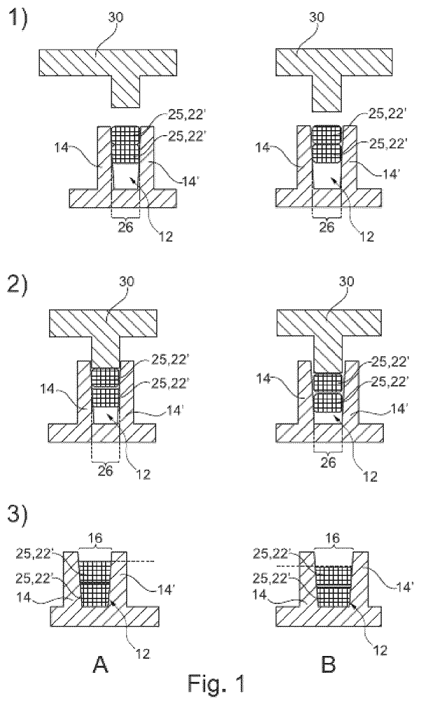

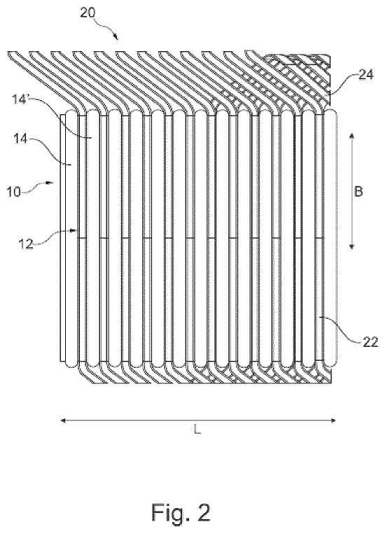

Below, FIG. 1 shows a receptacle 12 with straight wire sections 22, 22′, 22″, 22′″ of the wave winding 20 lying therein. It can be seen from FIG. 2 that a linear magazine 10 has a plurality of such receptacles 12 in its longitudinal direction L.

FIG. 1A and FIG. 1B each show a schematic representation of the method sequence for two different variants for shaping the stranded wires 25 in the linear magazine 10. For the method, straight wire sections 22, 22′, 22″, 22′″ of the stranded wires 25 of a wave winding 20 are first inserted into a linear magazine 10. For this purpose, the linear magazine 10 has receptacles 12, wherein the receptacles 12 are delimited in the longitudinal direction L of the linear magazine by webs 14, 14′. The receptacles 12 have an opening 16 via which the straight wire sections 22, 22′, 22″, 22′″ can be inserted into the receptacles 12 so that the straight wire sections 22, 22′, 22″, 22′″ lie in the receptacles 12 perpendicular to the longitudinal direction L of the linear magazine, i.e., in a width direction B. In this exemplary embodiment, the receptacle 12 has a receiving space with a conical cross-section, wherein the width of the receptacle 12 in the region of the opening 16 of the receptacle 12 is greater than in a lower region of the receptacle 12.

According to the method sequence from FIG. 1A, the stranded wires 25 with their straight sections 22, 22′, 22″, 22′″ are inserted into the receptacle 12, the wire width 26 substantially corresponding to the width of the receptacle 12 in the upper region and the width of the receptacle 12 decreasing with increasing depth of the receptacle and being smaller than the wire width 26.

In FIG. 1B, the stranded wires 25 with their straight sections 22, 22′, 22″ 22′″ are inserted into the receptacle 12, wherein the width of the receptacle 12 decreases with increasing depth of the receptacle 12 and the wire width 26 substantially corresponds to the width of the receptacle 12 in the lower region. In the region of the receptacle 12 which is close to the opening 16, the width of the receptacle 12 is greater than the wire width 26.

In the following step 2), the wave winding with its straight wire sections 22, 22′, 22″, 22′″ lying in the receptacles 12 of the linear magazine 10 is pressed by means of a pressing tool 30, as a result of which the stranded wires 25 are shaped and the stranded wires 25 with their straight wire sections 22, 22′, 22″, 22′″ are molded to the receptacles 12 and in particular to the webs 14, 14′.

For the variant according to FIG. 1A, a wire width of 26 was chosen which corresponds approximately to the mean width of the receptacle 12. As a result, after pressing, the lowest possible degree of shaping is achieved on average across all shape changes of the conductor wires 25, whereby the insulation of the stranded wires 25 is subjected to little stress. The lower straight wire section 22′ is compressed in the direction of the receptacle width or in the longitudinal direction L of the linear magazine 10, and the upper wire section 22 is stretched in the direction of the receptacle width or in the longitudinal direction L of the linear magazine 10.

For the variant according to FIG. 1B, the width of the receptacle 12 or the extension of the receptacle in the longitudinal direction L of the linear magazine was selected such that the wire width 26 is smaller than or equal to the smallest width of the conically tapered receptacle 12. This results in all straight wire sections 22, 22′ being stretched in the longitudinal direction L of the linear magazine 10. There is no displacement of the straight wire sections 22, 22′ perpendicular to this, which advantageously prevents any insulation damage from occurring.

In step 3), the final state of the shaped stranded wires 25 in the linear magazine 10 is shown. In a subsequent step (not shown), the conductor wires 25 or the wave winding 20 are removed from the linear magazine 10 and transferred into an insertion tool or into a rotor body or stator body 100.

It can be seen that the lower straight wire section 22′ in FIG. 1A was stretched in the longitudinal direction L of the linear magazine and the upper straight wire section 22 in FIG. 1A was compressed in the longitudinal direction L of the linear magazine 10 by the shaping. In FIG. 1B, both straight wire sections 22, 22′ were compressed in the longitudinal direction L by the shaping, resulting in a lower overall height of the wire pack compared to the design of the linear magazine 10 according to FIG. 1A.

A person skilled in the art will recognize that more than two layers of straight wire sections 22, 22′, 22″, 22′″ can lie in the receptacle 12 of the linear magazine 10. The pressing is carried out in step 2) with a suitable pressing tool 30, which engages in the receptacles 12 and there causes the shaping of the straight wire sections 22, 22′, 22″, 22′″ or conductor wires 25 by molding them to the webs 14, 14′of the receptacles 12. The shaping can be carried out for all receptacles 12 simultaneously (in FIG. 1 only one receptacle 12 of the linear magazine 10 is shown representatively), for example by means of a press stamp, but it is also conceivable that the straight wire sections 22, 22′, 22″, 22′″ are rolled into the receptacles 12 of the linear magazine 10 by a roller equipped with press webs. Of course, the variants with regard to the configuration of the width of the receptacles 12 relative to the wire width 26 according to FIGS. 1A and 1B can exist together within a linear magazine 10, wherein the width of the receptacles 12 can also change in the course of the linear magazine 10, i.e. in its longitudinal direction L.

For the sake of clarity, FIG. 2 shows a schematic partial representation of a top view of the linear magazine 10 with an inserted winding 20 in its design as a wave winding. It can be seen that the wave winding with the straight wire sections 22 of the conductor wires lies in the receptacles 12 of the linear magazine 10. The receptacles 12 are each delimited by webs 14, 14′. In the course of the stranded wires 25, the straight wire sections 22 are adjoined by winding heads 24 of the wave winding, which in this exemplary embodiment are located outside the receptacles 12 and outside the linear magazine 10. The winding heads 24 are located outside the receptacles 12 in the width direction B of the linear magazine 10. After subsequent use in a rotor body or stator body, the winding heads 24 protrude axially beyond this and thus initially increase the axial installation space requirement of an electric machine, which is a very limiting factor when used as an electric traction drive for electric or hybrid vehicles, for example. The heat dissipation of the winding heads protruding in this way is also often a particular challenge, as the thermal connection of the conductors to the stator or rotor lamination stack is not given.

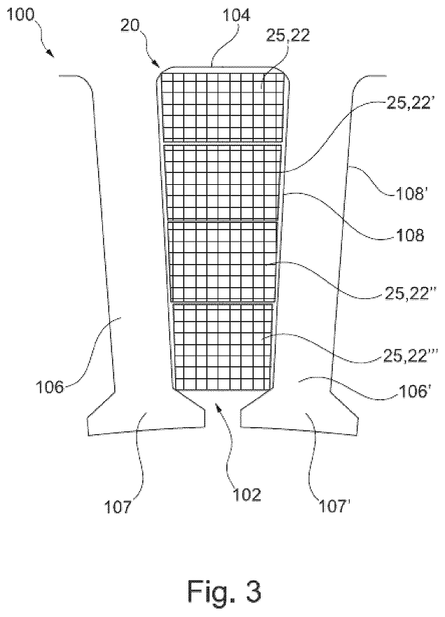

FIG. 3 shows a schematic partially axial sectional view of a part of the winding 20 inserted in a rotor body or stator body 100. The winding 20 is inserted into a slot 102, with the slot 102 being delimited on both sides by teeth 106, 106′ with parallel tooth flanks 108, 108′, resulting in a radially different slot width, which in the exemplary embodiment shown increases with increasing radius. The slot 102 is delimited radially outwards by a slot base 104 and radially inwards by yoke sections 107, 107′ of the teeth 106, 106′. The wave winding almost completely fills the slot 102 with the straight wire sections 22, 22′, 22″, 22′″ shaped according to the method described above. Here, not only two layers of stranded wires 25, but four layers of stranded wires 25 or straight wire sections 22, 22′, 22″, 22′″ are inserted into a slot 102 of a rotor body or stator body 100. In one variant, these four layers may each have been formed in the receptacles 12 of the linear magazine 10, or the wave winding was formed in two layers, wherein the winding 20 was then inserted into the substantially cylindrical rotor body or stator body 100 in two revolutions. It is understood that the shaping in the linear magazine 10 must then take place according to the later position in the rotor body or stator body, the receptacle geometry changing accordingly in the longitudinal direction L of the linear magazine 10 in order to be adapted to the radially changing slot cross-section of the rotor body or stator body 100. For this purpose, the linear magazine 10 can have a fixed geometry or, to a certain degree, movable or exchangeable webs 14, 14′ or boundaries of the receptacles 12.

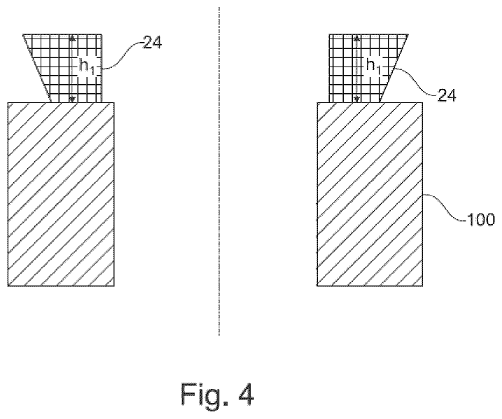

FIG. 4 shows a schematic sectional view of a stator body 100 with inserted wave winding. The straight wire sections (22, 22′, 22″, 22′″) of the stranded wires 25 lie in the slots 102 of the stator body and winding heads 24 protrude axially above the stator body 100 by a height h1.

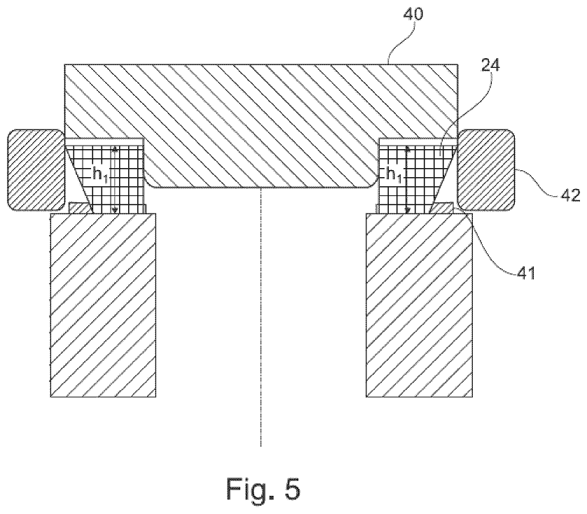

FIG. 5 shows a schematic sectional view of the stator body 100 with inserted wave winding during compacting of the winding heads 24 with a first embodiment of a compacting press 40. In addition to the compacting press 40, a molding tool 42 designed as an open diameter ring is arranged radially surrounding the winding heads 24, as well as support fingers 41. A support finger 41 is mounted on each stator tooth. Its task is to protect a slot insulation paper (not shown) from damage during the compacting process. The support fingers 41 fix the bending area of the winding head 24 at a defined distance from the stator body 100 so that the slot insulation is prevented from buckling on the stator body 100.

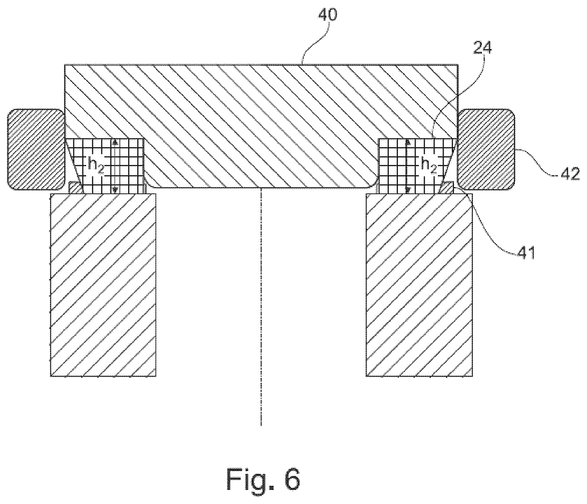

To compact the wrapping heads 24, the compacting press 40 is moved axially towards the stator body so that the wrapping heads 24 are compressed from the first height h1 to the second height h2. This final state is shown in FIG. 6.

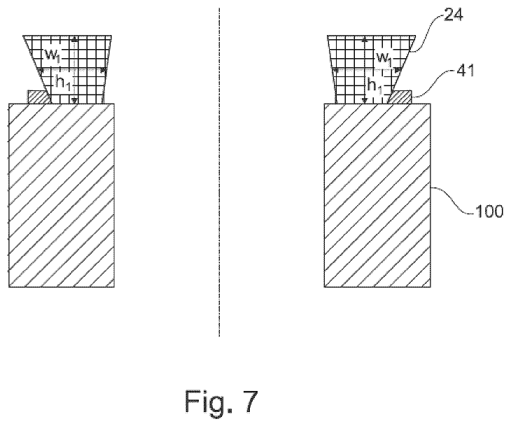

FIG. 7 shows a further schematic sectional view of a stator body 100 with inserted wave winding and axially protruding winding heads. In addition to the initial height h1 of the winding heads 24, the radial initial width w1 is also shown.

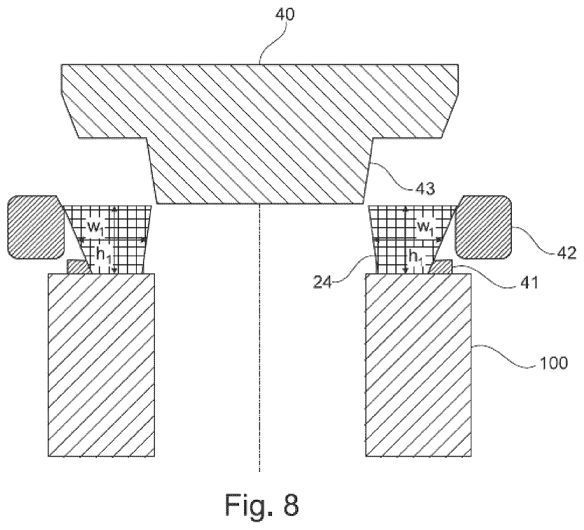

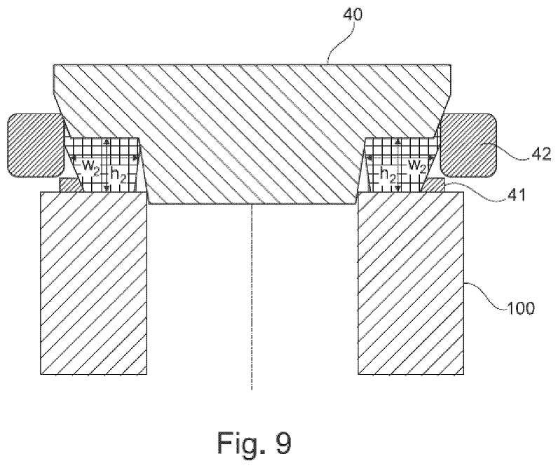

FIG. 8 shows a schematic sectional view of the stator body 100 with inserted wave winding during compacting of the winding heads 24 with a second embodiment of a compacting press 40. This second version of the compacting press 40 has bevels 43 which, when the compacting press 40 is pressed axially against the stator body 100, also cause radial compression of the winding heads 24 in addition to axial compression. FIG. 9 shows that, at the end of the compacting process, the winding heads have been reduced both in terms of their axial expansion (from h1 to h2) and their radial expansion (from w1 to w2).

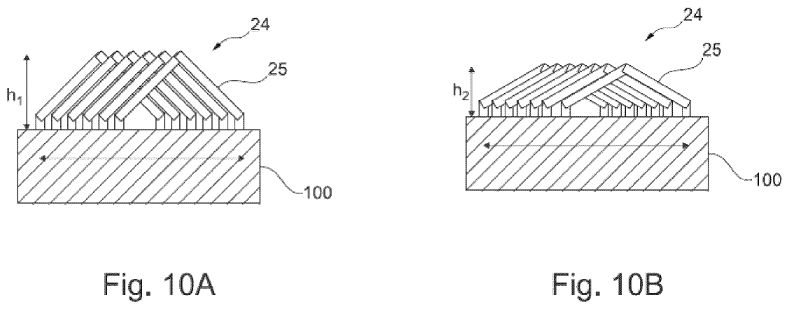

FIGS. 10A and 10B show a side view of the winding heads before and after compacting. The reduction of the axial conductor height in the winding head from h1 to h2 can also be seen here.

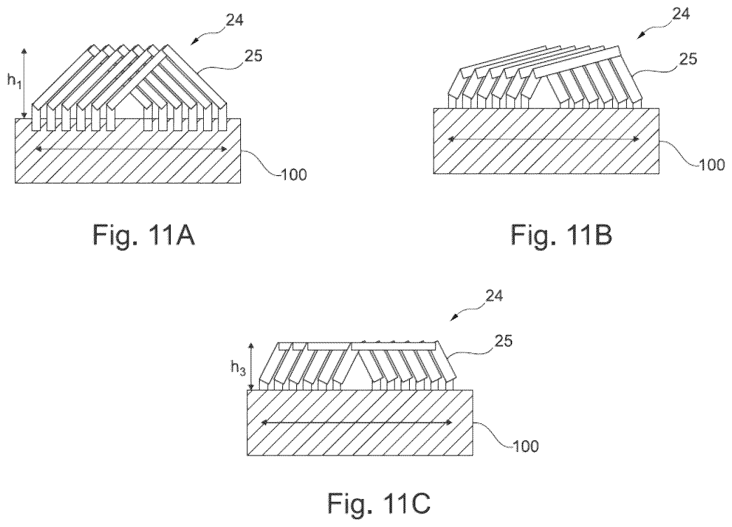

FIGS. 11A, 11B and 11C, on the other hand, show a side view of the winding heads 24 when the compacting press 40 rotates during the pressing process. The conductor profile in the winding head 24 can be modified by a predetermined angle of rotation, which accompanies the axial pressing process of the compacting press 40 in a similar way to a screwing-in process, so that its axial expansion is reduced even further.

All of the features and advantages resulting from the claims, description, and drawing, including constructive details, spatial arrangements, and method steps, may be essential to the disclosure either alone or in various combinations.

### LIST OF REFERENCE SYMBOLS

10 Magazine, linear magazine
12 Receptacle
14, 14′ Web
16 Opening
20 Winding
22, 22′, 22″, 22′″ Straight wire section
24 Winding head
25 Stranded wire
26 Wire width
27 Single wire
28 Shaped stranded wire
29 Loose stranded wire
30 Pressing tool
40 Compacting press
41 Support finger
42 Molding tool
43 Bevels
100 Rotor body or stator body
102 Slot
104 Slot base
106, 106′ Tooth
107, 107′ Yoke section
108, 108′ Tooth flank
L Longitudinal direction
B Width direction

1. A method for reshaping and introducing a winding into a rotor body or stator body of an electric machine, the method comprising:
preforming a stranded wire to create the winding, such that straight sections of the stranded wire are connected via bent winding head sections of the stranded wire so as to form a wave winding or loop winding;
introducing the winding into the rotor body or stator body such that the straight sections come to lie in slots of the electric machine and the winding head sections of the winding protrude on axial end faces of the rotor body or stator body; and
compacting the winding head sections so as to reduce their axial protrusion.

2. The method according to claim 1, wherein a profiled stranded wire is used as the stranded wire.

3. The method according to claim 1, wherein, before introducing the winding into the rotor body or stator body, the method further comprises
introducing the winding into a magazine, wherein the straight sections of the stranded wire are inserted into slot-shaped receptacles of the magazine; and
pressing the stranded wires into the receptacles of the magazine, whereby the stranded wires are molded to the receptacles.

4. The method according to claim 3, wherein the stranded wires in the receptacles are shaped to form a conical cross-section.

5. The method according to claim 1, wherein, for compacting with a compacting press, the winding head sections are pressed axially against the rotor body or stator body.

6. The method according to claim 5, wherein a support finger is mounted on each stator tooth before pressing, which protects a slot projection of a slot insulation during the pressing process.

7. The method according to claim 5, wherein a molding tool is arranged enclosing the winding head sections in order to limit radial expansion of the winding head sections during the pressing process.

8. The method according to claim 5, wherein the compacting press is rotated by a predetermined angle of rotation relative to the stator body or rotor body during the axial pressing process.

9. The method according to claim 1, wherein a compacting press is used for axial pressing, which compacting press has bevels through which the winding head sections are pressed radially outwards while the compacting press is moved axially in the direction of the rotor package or stator package.

10. The method according to claim 1, wherein, after compacting the winding head sections to reduce the axial protrusion, the winding is cemented to fix the winding.

11. A stator of an electric machine having a stator body with slots and having a winding made of stranded wire, in which straight sections of the stranded wire are connected via bent winding head sections of the stranded wire to form a wave winding or loop winding, the straight sections come to lie in the slots and the winding head sections of the winding protrude from axial end faces of the stator body, wherein the winding head sections are compacted.

12. A rotor of an electric machine having a rotor body with slots and having a winding made of stranded wire, in which straight sections of the stranded wire are connected via bent winding head sections of the stranded wire to form a wave winding or loop winding, the straight sections come to lie in the slots and the winding head sections of the winding protrude from axial end faces of the rotor body, wherein the winding head sections are compacted.

13. The stator according to claim 11, wherein the stranded wire comprises a profiled stranded wire.

14. The stator according to claim 13, wherein the stranded wire comprises a profiled stranded wire having a rectangular cross-section.

15. The stator according to claim 11, wherein the stranded wires have a conical cross-section.

16. The stator according to claim 11, wherein the winding is fixed via cementing varnish.

17. The rotor according to claim 12, wherein the stranded wire comprises a profiled stranded wire.

18. The rotor according to claim 17, wherein the stranded wire comprises a profiled stranded wire having a rectangular cross-section.

19. The rotor according to claim 12, wherein the stranded wires have a conical cross-section.

20. The rotor according to claim 12, wherein the winding is fixed via cementing varnish.
